(19) United States
(12) Patent Application Publication
(10) Pub. No.: US 2026/0302067 A1
(43) Pub. Date: Oct. 1, 2026

(54) DIELECTRIC FILM AND METHOD FOR MANUFACTURING THE SAME, METALIZED FILM AND METHOD FOR MANUFACTURING THE SAME, FILM CAPACITOR AND METHOD FOR MANUFACTURING THE SAME, INVERTER, AND VEHICLE

(71) Applicant: Panasonic Intellectual Property Management Co., Ltd., Osaka (JP)

(72) Inventors: YOICHI OGOSHI, Kyoto (JP); NOBUYUKI SETO, Osaka (JP)

(21) Appl. No.: 19/543,912

(22) Filed: Feb. 19, 2026

(30) Foreign Application Priority Data
Mar. 28, 2025 (JP) 2025-057210

(51) Int. Cl. H01G 4/18; H01G 4/012

(52) U.S. Cl. CPC H01G 4/18; H01G 4/012

(57) ABSTRACT

A dielectric film includes polypropylene. In a diffraction pattern of X-ray diffraction measurement to the dielectric film, a ratio (IB/IA) of a peak intensity IB to a peak intensity IA is 0.527 or more, the peak intensity IA being derived from a (040) plane of an α crystal of the polypropylene, the peak intensity IB being derived from a (060) plane of an α crystal of the polypropylene.

### BACKGROUND

### 1. Technical Field

The present disclosure generally relates to a dielectric film and a method for manufacturing the dielectric film, a metalized film and a method for manufacturing the metalized film, a film capacitor and a method for manufacturing the film capacitor, an inverter, and a vehicle. More specifically, the present disclosure relates to a dielectric film including polypropylene and a method for manufacturing the dielectric film, a metalized film and a method for manufacturing the metalized film, a film capacitor and a method for manufacturing the film capacitor, an inverter, and a vehicle.

### 2. Description of the Related Art

Unexamined Japanese Patent Publication No. 2016-188361 discloses a biaxially oriented polypropylene film for a capacitor. The thickness (t1) of the biaxially oriented polypropylene film for a capacitor measured by a micrometer method ranges from 1.5 μm to 4 μm. The biaxially oriented polypropylene film for a capacitor includes a polypropylene resin having a meso-pentad fraction (mmmm) of 95% or more and less than 98%. Furthermore, the orientation parameter PMD in the longitudinal direction and the orientation parameter PTD in the width direction of the biaxially oriented polypropylene film for a capacitor satisfy a predetermined expression.

### SUMMARY

A dielectric film according to one aspect of the present disclosure includes polypropylene. In a diffraction pattern of X-ray diffraction measurement to the dielectric film, a ratio (IB/IA) of a peak intensity IB to a peak intensity IA is 0.527 or more, the peak intensity IA being derived from a (040) plane of an α crystal of the polypropylene, the peak intensity IB being derived from a (060) plane of an α crystal of the polypropylene.

A dielectric film according to one aspect of the present disclosure includes polypropylene. When an orientation parameter PA in an MD direction (machine direction) of the dielectric film and an orientation parameter PB in a TD direction (transverse direction) of the dielectric film are respectively represented in the following expressions, 2.2≤(PB/PA) is satisfied.

$$PA = ( A 972 / A 1376 )$$

$$PB = ( B 972 / B 1376 )$$

where
A972 represents an absorption peak intensity at a wavenumber of 972 cm⁻¹ in a Fourier Transform Infrared Spectroscopy spectrum measured in a state where a light source is polarized in the MD direction,
A1376 represents an absorption peak intensity at a wavenumber of 1376 cm⁻¹ in the Fourier Transform Infrared Spectroscopy spectrum measured in the state where the light source is polarized in the MD direction,
B972 represents an absorption peak intensity at a wavenumber of 972 cm⁻¹ in a Fourier Transform Infrared Spectroscopy spectrum measured in a state where the light source is polarized in the TD direction, and
B1376 represents an absorption peak intensity at a wavenumber of 1376 cm⁻¹ in the Fourier Transform Infrared Spectroscopy spectrum measured in the state where the light source is polarized in the TD direction.

A metalized film according to one aspect of the present disclosure includes the dielectric film and a metal layer disposed on the dielectric film.

A film capacitor according to one aspect of the present disclosure includes the metalized film.

An inverter according to one aspect of the present disclosure includes the film capacitor.

A vehicle according to one aspect of the present disclosure includes the inverter.

A method for manufacturing a dielectric film according to one aspect of the present disclosure includes: a preparation step of preparing a dielectric film including polypropylene; and a processing step of subjecting the dielectric film to tensile processing at a tensile stress more than or equal to a yield point of the dielectric film, the tensile processing being performed at a temperature of at 80° C. or lower.

A method for manufacturing a metalized film according to one aspect of the present disclosure includes a vapor deposition step of vapor-depositing a metal on the dielectric film.

A method for manufacturing a film capacitor according to one aspect of the present disclosure includes a winding step of winding the metalized film.

According to the present disclosure, it is possible to improve withstand voltage characteristics in a high-temperature environment.

### BRIEF DESCRIPTION OF THE DRAWINGS

FIG. 1 is a schematic perspective view illustrating a manufacturing process of a wound body to be used in a film capacitor according to the present exemplary embodiment;

FIG. 2 is a schematic perspective view illustrating the film capacitor according to the present exemplary embodiment;

FIG. 3 is a block diagram illustrating an inverter according to the present exemplary embodiment; and

FIG. 4 is a schematic configuration diagram illustrating a vehicle according to the present exemplary embodiment.

### DETAILED DESCRIPTIONS OF EMBODIMENTS

Hereinafter, problems of the prior art will be briefly described.

In the biaxially oriented polypropylene film for a capacitor disclosed in Unexamined Japanese Patent Publication No. 2016-188361, there is room for improvement in withstand voltage characteristics in a high-temperature environment. Here, the high-temperature environment refers to an environment corresponding to a temperature ranging from 120° C. to 140° C., for example, in in-vehicle applications and industrial equipment applications although it varies depending on the use environment and required specifications.

The present disclosure provides a dielectric film capable of improving withstand voltage characteristics in a high-temperature environment, a method for manufacturing the dielectric film, a metalized film and a method for manufacturing the metalized film, a film capacitor and a method for manufacturing the film capacitor, an inverter, and a vehicle.

### 1. Overview

The present inventors performed X-ray diffraction measurement (XRD) on a film including polypropylene that was α crystalline plastic. As a result, the present inventors found that the ratios of the peak intensities derived from two specific crystal planes of the α crystal were correlated with the withstand voltage characteristics in a high-temperature environment. That is, the present inventors found that when the ratio was a certain value or more, the withstand voltage characteristics in a high-temperature environment were improved. As a result of further research based on this finding, the present inventors have developed the following dielectric film 1.

That is, in a diffraction pattern of X-ray diffraction measurement to dielectric film 1 according to the present exemplary embodiment, the ratio (IB/IA) of peak intensity IB derived from the (060) plane of the α crystal of polypropylene to peak intensity IA derived from the (040) plane of the α crystal of polypropylene is 0.527 or more.

Thus, according to the present exemplary embodiment, it is possible to improve the withstand voltage characteristics in a high-temperature environment.

Furthermore, as a result of performing FT-IR measurement (Fourier Transform Infrared Spectroscopy) using polarized light on a film including polypropylene that is a crystalline plastic, the present inventors have found that the ratio (PB/PA) of the orientation parameter PB in the TD direction (transverse direction) to the orientation parameter PA in the MD direction (machine direction) is also correlated with the withstand voltage characteristics in a high temperature environment. This point will be described later.

### 2. Details

### (1) Dielectric Film

First, a dielectric film 1 according to the present exemplary embodiment will be described. Dielectric film 1 includes polypropylene. Polypropylene is α crystalline plastic. The content proportion of polypropylene in the entire dielectric film 1 is preferably 90 mass % or more and 100 mass % or less, more preferably 95 mass % or more and 100 mass % or less, and still more preferably 100 mass %.

Dielectric film 1 according to the present exemplary embodiment can be identified based on the measurement results of X-ray diffraction measurement and polarized FT-IR measurement. Hereinafter, X-ray diffraction measurement and polarized FT-IR measurement will be separately described.

### <X-ray Diffraction Measurement>

Dielectric film 1 according to the present exemplary embodiment includes polypropylene, and its crystal structure is controlled to satisfy specific conditions.

Specifically, a ratio (IB/IA) of a peak intensity IB to a peak intensity IA in a diffraction pattern of X-ray diffraction measurement to dielectric film 1 is controlled to be 0.527 or more, where the peak intensity IB is derived from the (060) plane of the α crystal of polypropylene and the peak intensity IA is derived from the (040) plane of the α crystal of polypropylene.

In general, polypropylene is a material having crystallinity, and is known to form polymorphs such as α crystal, β crystal, and γ crystal. Among them, the α crystal is the most stable crystal phase, and greatly affects the electrical characteristics and mechanical characteristics required for dielectric film 1. In the present exemplary embodiment, the performance of dielectric film 1 is improved particularly by controlling the orientation of the (060) plane of the α crystal.

In the X-ray diffraction measurement, the peak intensity derived from the (040) plane and the (060) plane of the α crystal is an index showing the orientation of the crystal structure of polypropylene. In general, in a general polypropylene film, the peak intensity IB of the (060) plane is lower than the peak intensity IA of the (040) plane.

However, in dielectric film 1 according to the present exemplary embodiment, the orientation of the (060) plane is improved and the ratio (IB/IA) is controlled to 0.527 or more by performing specific processing (cold stretching treatment) and heat treatment in the manufacturing process, as will be described later in the section of “(2) Method for Manufacturing Dielectric Film.” As a result, the electrical characteristics (for example, dielectric characteristics) of dielectric film 1 are improved, and the withstand voltage characteristics particularly in a high-temperature environment can be improved. The upper limit value of the ratio (IB/IA) is not particularly limited, and is, for example, 0.650.

### <Polarized FT-IR Measurement>

The crystal orientation of dielectric film 1 according to the present exemplary embodiment is controlled to satisfy a specific condition. In particular, in dielectric film 1 according to the present exemplary embodiment, the orientation parameter PA in the MD direction (machine direction, longitudinal direction) of dielectric film 1 and the orientation parameter PB in the TD direction (lateral direction, short direction) of dielectric film 1 are adjusted to satisfy 2.2≤(PB/PA).

Here, the orientation parameter PA and the orientation parameter PB are obtained by measurement using Fourier Transform Infrared Spectroscopy (FT-IR). Specifically, they are defined by the following expression.

$$PA = ( A 972 / A 1376 )$$

$$PB = ( B 972 / B 1376 )$$

Here, A972 represents an absorption peak intensity at a wavenumber of 972 cm⁻¹ of an FT-IR spectrum measured in a state where the light source is polarized in the MD direction.

A1376 represents an absorption peak intensity at a wavenumber of 1376 cm⁻¹ of the FT-IR spectrum measured in the state where the light source is polarized in the MD direction.

B972 represents an absorption peak intensity at a wavenumber of 972 cm⁻¹ of an FT-IR spectrum measured in a state where the light source is polarized in the TD direction.

B1376 represents an absorption peak intensity at a wavenumber of 1376 cm⁻¹ of the FT-IR spectrum measured in the state where the light source is polarized in the TD direction.

It is known that a peak at 972 cm⁻¹ in FT-IR measurement indicates an absorption related to the crystalline orientation of polypropylene, while a peak at 1376 cm⁻¹ indicates an absorption including an non-crystalline portion. Therefore, the orientation parameter PA is an index indicating the degree of crystal orientation in the MD direction, and the orientation parameter PB is an index indicating the degree of crystal orientation in the TD direction.

In general, when a polypropylene film is stretched while being heated, orientation in the MD direction tends to be stronger.

However, in dielectric film 1 according to the present exemplary embodiment, the orientation in the MD direction is enhanced, and the ratio (PB/PA) of the orientation parameter PB to the orientation parameter PA is controlled to 2.2 or more by performing specific processing (cold stretching treatment) and heat treatment in the manufacturing process, as will be described later in the section of “(2) Method for Manufacturing Dielectric Film.” This improves the balance of the mechanical strength of dielectric film 1, and improves the electrical characteristics. Specifically, this makes it possible to improve the withstand voltage characteristics in a high-temperature environment.

Preferably, the orientation parameter PA in the MD direction of dielectric film 1 and the orientation parameter PB in the TD direction of dielectric film 1 satisfy (PB/PA)≤2.4. This makes it possible to further improve the withstand voltage characteristics in a high-temperature environment while suppressing the occurrence of cracks.

### (2) Method for Manufacturing Dielectric Film

Next, a method for manufacturing dielectric film 1 according to the present exemplary embodiment will be described. The method for manufacturing dielectric film 1 includes a preparation step and a processing step. Preferably, the method for manufacturing dielectric film 1 further includes a heat treatment step.

Hereinafter, the material to be used for producing dielectric film 1 according to the present exemplary embodiment may be referred to as “unprocessed dielectric film”. The “unprocessed dielectric film” means a dielectric film before undergoing a processing step.

On the other hand, dielectric film 1 according to the present exemplary embodiment means a finished product. The finished product may be referred to as a “processed dielectric film” or a “heat-treated dielectric film”. The “processed dielectric film” means dielectric film 1 after undergoing a processing step, and the “heat-treated dielectric film” means dielectric film 1 after undergoing up to a heat treatment step. As described above, dielectric film 1 according to the present exemplary embodiment includes the “processed dielectric film” and the “heat-treated dielectric film”.

### <Preparation Step>

In the preparation step, an unprocessed dielectric film is prepared. The unprocessed dielectric film includes polypropylene.

In the unprocessed dielectric film, the ratio (IB/IA) is less than 0.527 and (PB/PA) is less than 2.2. That is, as the unprocessed dielectric film, a polypropylene film generally used for a film capacitor can be used. For example, a biaxially stretched polypropylene film can be used as the unprocessed dielectric film. The biaxially stretched polypropylene film is a film having an isotactic structure obtained by adding an additive to polypropylene as necessary, melt-kneading the mixture, extruding the mixture, and stretching the mixture in the MD direction and the TD direction. The additive is not particularly limited, and examples thereof include an α-crystal nucleating agent, a β-crystal nucleating agent, a heat stabilizer, and an antioxidant.

The thickness of the unprocessed dielectric film is not particularly limited, and is, for example, 1.5 μm or more and 4 μm or less.

### <Processing Step>

In the processing step, the unprocessed dielectric film is cold-stretched. Specifically, in the processing step, the unprocessed dielectric film is subjected to tensile processing at 80° C. or lower (preferably 30° C. or higher and 45° C. or lower) with a tensile stress more than or equal to the yield point of the unprocessed dielectric film.

Here, the yield point (usually, the upper yield point) is the maximum stress at the time of transition from elastic deformation to plastic deformation in a stress-strain curve (S-S curve), and refers to a point from which a characteristic is indicated that the stress decreases and plastic flow starts. Note that the stress-strain curve is a graph illustrating a relationship between stress and strain with the stress on the vertical axis and the strain on the horizontal axis.

Preferably, in the processing step, the tensile stress in the tensile processing is 50 MPa or more and 100 MPa or less. This makes it possible to obtain dielectric film 1 in which the withstand voltage characteristics in a high-temperature environment are further improved while the occurrence of cracks is suppressed.

Preferably, in the processing step, the tensile direction of the tensile processing coincides with the MD direction of the dielectric film. This makes it possible to obtain dielectric film 1 with improved withstand voltage characteristics in a high-temperature environment.

Preferably, in the processing step, the tensile speed of the tensile processing is 2 mm/min or more and 10 mm/min or less.

In this way, dielectric film 1 (processed dielectric film) according to the present exemplary embodiment is obtained. Preferably, the following heat treatment step is continued after the processing step.

### <Heat Treatment Step>

In the heat treatment step, the processed dielectric film is subjected to a heat treatment. Specifically, in the heat treatment step, the processed dielectric film is heated at a temperature of 110° C. or more and 140° C. or less. In this manner, the processed dielectric film is subjected to an annealing treatment. Thereafter, slow cooling or natural cooling is performed. As a result, the crystal structure of the processed dielectric film can be improved, the internal stress thereof can be removed, and the thermal shrinkage amount thereof can be controlled. Therefore, it is possible to obtain dielectric film 1 with further improved withstand voltage characteristics in a high-temperature environment.

Preferably, in the heat treatment step, the heat treatment is performed while the processed dielectric film is run in the MD direction. This makes it possible to obtain dielectric film 1 having further improved withstand voltage characteristics in a high-temperature environment.

Preferably, the processed dielectric film is not subjected to tensile processing in the heat treatment step. That is, in the heat treatment step, it is preferable to perform heat treatment to the processed dielectric film without performing tensile processing.

In this way, dielectric film 1 (heat-treated dielectric film) according to the present exemplary embodiment is obtained.

### EXAMPLES

### Comparative Example 1

As an unprocessed dielectric film, a biaxially stretched polypropylene film having a thickness of 2.1 μm was prepared. X-ray diffraction measurement and FT-IR measurement were performed using this polypropylene film as it was.

### Comparative Example 2

The same polypropylene film as that of Comparative Example 1 was prepared, and this polypropylene film was subjected to tensile processing at 40° C. in the MD direction at a tensile stress (specifically, 30 MPa) lower than the yield point, and was then subjected to heat treatment at 120° C. The polypropylene film thus treated was subjected to X-ray diffraction measurement and FT-IR measurement.

### Comparative Example 3

Comparative Example 3 was similar to Comparative Example 2 except that the tensile stress of Comparative Example 2 was changed to 40 MPa.

### Example 1

The same polypropylene film as that of Comparative Example 1 was prepared, and this polypropylene film was subjected to tensile processing at 40° C. in the MD direction at a tensile stress (specifically, 50 MPa) greater than or equal to the yield point, and was then subjected to heat treatment at 120° C. The polypropylene film thus treated was subjected to X-ray diffraction measurement and FT-IR measurement.

### Example 2

The process was similar to that in Example 1 except that the tensile stress in Example 1 was changed to 60 MPa.

### Example 3

The process was similar to that in Example 1 except that the tensile stress in Example 1 was changed to 100 MPa.

### Example 4

The process was similar to that in Example 1 except that the tensile stress in Example 1 was changed to 140 MPa.

Next, for each of the samples of Comparative Examples 1 to 3 and Examples 1 to 4 obtained as described above, X-ray diffraction measurement was performed as follows, withstand voltage characteristics (potential gradient) were further measured, and the presence or absence of cracks was confirmed.

### <<X-Ray Diffraction Measurement>>

The measurement was performed using an X-ray diffractometer (CuKα radiation, λ=1.5418 Å) under the conditions of an X-ray tube voltage of 40 kV and a current of 30 mA, under the conditions of a 2θ range of 5° to 50°, a scanning speed of 2°/min, and a step size of 0.02°. From the obtained diffraction pattern, a peak intensity IA derived from the (040) plane of the α crystal and a peak intensity IB derived from the (060) plane of the α crystal were measured, and a ratio (IB/IA) was calculated. The results are shown in Table 1.

### <<Withstand Voltage Characteristics (Potential Gradient)>>

Under environments of 23° C. and 120° C., average values were obtained according to JIS C2330 (2001) 7.4.11.2 B method (flat plate electrode method), and the average values were divided by the thickness of the film to calculate withstand voltage characteristics (potential gradient). The results are shown in Table 1.

### <<Crack>>

Presence or absence of a crack was visually confirmed. The results are shown in Table 1. “OK” indicates that no crack was found, and “NG” indicates that a crack was found.

TABLE 1

| | | | | Peak | | | |
|---|---|---|---|---|---|---|---|
| | Tensile | Peak | Peak | intensity | Potential gradient | | |
| | stress | intensity | intensity | ratio | (V/μm) | | Evaluation |
| | (MPa) | IA (040) | IB (060) | IB/IA | 23° C. | 120° C. | Crack |
| Comparative | 0 | 475839 | 21038 | 0.044 | 430 | 285 | OK |
| Example 1 | | | | | | | |
| Comparative | 30 | 464178 | 22059 | 0.048 | 608 | 264 | OK |
| Example 2 | | | | | | | |
| Comparative | 40 | 451372 | 44944 | 0.100 | 623 | 224 | OK |
| Example 3 | | | | | | | |
| Example 1 | 50 | 551594 | 290825 | 0.527 | 645 | 438 | OK |
| Example 2 | 60 | 603650 | 387388 | 0.642 | 655 | 450 | OK |
| Example 3 | 100 | 625892 | 417855 | 0.668 | 685 | 465 | OK |
| Example 4 | 140 | 632917 | 422186 | 0.667 | 688 | 465 | NG |

Next, polarized FT-IR measurement was performed on each of the samples of Comparative Examples 1 to 3 and Examples 1 to 4 as follows.

### <<Polarized FT-IR Measurement>

Measurement was performed in transmission mode using a Fourier Transform Infrared Spectrophotometer. The measurement conditions were a resolution of 4 cm⁻¹, a number of scans of 32, and a measurement range of 600 cm⁻¹ to 2000 cm⁻¹. Spectra of each of the samples in MD and TD directions were acquired using a polarizing filter.

From the measurement results, the absorption peak intensity (A972) at a wavenumber of 972 cm⁻¹ and the absorption peak intensity (A1376) at a wavenumber of 1376 cm⁻¹ in the MD direction, and the absorption peak intensity (B972) at a wavenumber of 972 cm⁻¹ and the absorption peak intensity (B1376) at a wavenumber of 1376 cm⁻¹ in the TD direction were calculated to determine the orientation parameters (PA and PB) and PB/PA. The results are shown in Table 2.

Note that the withstand voltage characteristics (potential gradient) and results of evaluation of cracks in Table 1 are transcribed to Table 2.

TABLE 2

| | | | FT-IR | FT-IR | | | | | |
|---|---|---|---|---|---|---|---|---|---|
| | | | peak | peak | | | | | |
| | Tensile stress | | intensity | intensity | Peak | PB/PA | Potential gradient | | |
| | (MD direction) | | 1376 | 972 | intensity | intensity | (V/μm) | | Evaluation |
| | (MPa) | | cm⁻¹ | cm⁻¹ | ratio | ratio | 23° C. | 120° C. | Crack |
| Comparative | 0 | MD | 0.199 | 0.029 | 0.147 | 2.005 | 430 | 285 | OK |
| Example 1 | | direction | | | | | | | |
| | | TD | 0.154 | 0.046 | 0.295 | | | | |
| | | direction | | | | | | | |
| Comparative | 30 | MD | 0.214 | 0.030 | 0.138 | 2.123 | 608 | 264 | OK |
| Example 2 | | direction | | | | | | | |
| | | TD | 0.156 | 0.046 | 0.294 | | | | |
| | | direction | | | | | | | |
| Comparative | 40 | MD | 0.220 | 0.030 | 0.135 | 2.175 | 623 | 224 | OK |
| Example 3 | | direction | | | | | | | |
| | | TD | 0.156 | 0.046 | 0.294 | | | | |
| | | direction | | | | | | | |
| Example 1 | 50 | MD | 0.224 | 0.030 | 0.133 | 2.202 | 645 | 438 | OK |
| | | direction | | | | | | | |
| | | TD | 0.157 | 0.046 | 0.293 | | | | |
| | | direction | | | | | | | |
| Example 2 | 60 | MD | 0.228 | 0.030 | 0.131 | 2.235 | 655 | 450 | OK |
| | | direction | | | | | | | |
| | | TD | 0.158 | 0.046 | 0.293 | | | | |
| | | direction | | | | | | | |
| Example 3 | 100 | MD | 0.242 | 0.030 | 0.125 | 2.336 | 685 | 465 | OK |
| | | direction | | | | | | | |
| | | TD | 0.159 | 0.047 | 0.292 | | | | |
| | | direction | | | | | | | |
| Example 4 | 140 | MD | 0.262 | 0.031 | 0.117 | 2.486 | 688 | 465 | NG |
| | | direction | | | | | | | |
| | | TD | 0.161 | 0.047 | 0.291 | | | | |
| | | direction | | | | | | | |

### EFFECTS

The effects of dielectric film 1 according to the present exemplary embodiment and the method for manufacturing the same will be described. Note that the description of the mechanism leading to the effects includes presumption.

Generally, a polymer constituting a film of α crystalline plastic such as polypropylene is divided into α crystalline portion and a non-crystalline portion. The crystalline portion is a region in which lamellar crystals are regularly arranged. On the other hand, the non-crystalline portion is a glassy amorphous portion. The non-crystalline portion includes a portion in which tie molecules are randomly intertwined.

When a voltage is applied to the film at the time of measuring the withstand voltage of the film as described above, the released protons may penetrate the non-crystalline portion, and the withstand voltage may be lowered by the film being broken.

In the present exemplary embodiment, by subjecting a normal film to specific processing (cold stretching treatment), tie molecules are stretched, and lamellar crystals are aligned accordingly. This is considered to increase the peak intensity of the (060) plane of the α crystal in the X-ray diffraction measurement. Note that the specific processing is processing in the processing step described in the section of “(2) Method For Manufacturing Dielectric Film” described above.

In addition, it is considered that when a normal film is subjected to specific processing (cold stretching treatment), the orientation in the MD direction is enhanced. When the orientation in the MD direction is enhanced, the decrease width of the orientation parameter PA in the MD direction is larger than the decrease width of the orientation parameter PB in the TD direction. Then, the ratio (PB/PA) of the orientation parameters PB and PA can be easily controlled to 2.2 or more.

The mechanism by which the orientation in the MD direction is enhanced is presumed as follows. In the process of applying stress to the tie molecules, frictional heat is generated between the tie molecules and the non-crystalline portion, and the non-crystalline portion around the tie molecules is partially crystallized. This reduces the volume of the non-crystalline portion and improves the crystallinity. As described above, since the orientation of the crystals is aligned in the MD direction, it is considered that the orientation in the MID direction is enhanced.

The protons released at the time of the withstand voltage test collide with the crystalline portion when passing through the increased crystal phase, and the kinetic energy thereof is converted into thermal energy to disappear. This improves the withstand voltage of the film.

However, in some cases, the tie molecules stretched by tensile stretching may gradually shrink when left as they are, and so-called thermal shrinkage may occur.

Therefore, in the present exemplary embodiment, shrinkage of the structure of the extended polymer is suppressed by performing the annealing treatment. The part of the non-crystalline portion where the non-crystalline portion around the tie molecule is crystallized further becomes thicker, and the lamellar crystal also grows thicker. As a result, the probability of proton collision is increased, and the withstand voltage of the film is further increased. Note that the annealing treatment is the heat treatment in the heat treatment step described in the section of “(2) Method for Manufacturing Dielectric Film” described above. The growth of the crystal phase increases the melting point, thereby improving the heat resistance.

As described above, according to dielectric film 1 and the method for manufacturing the same according to the present exemplary embodiment, it is possible to improve the withstand voltage characteristics in a high-temperature environment.

### (3) Metalized Film

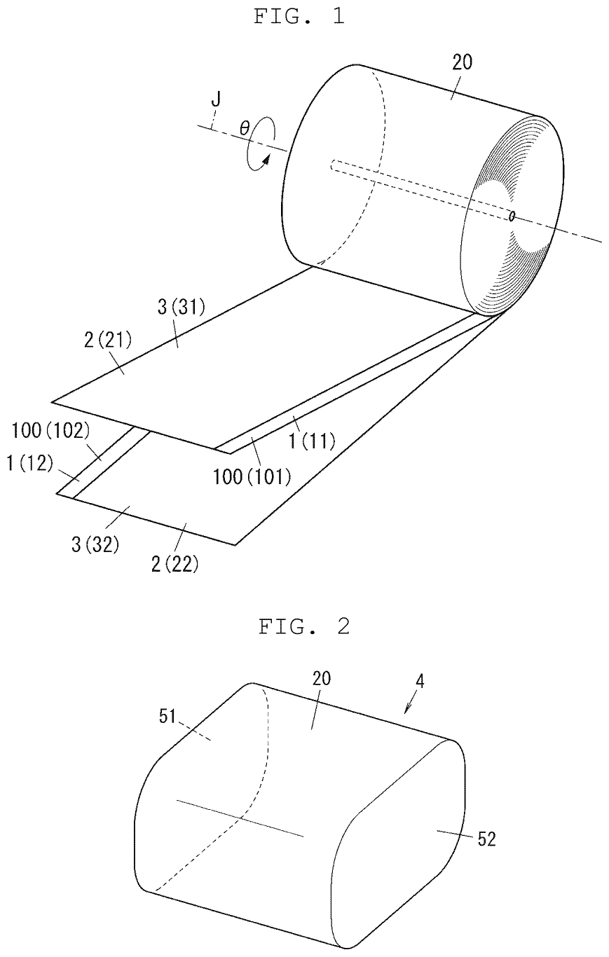

Next, metalized film 2 according to the present exemplary embodiment will be described with reference to FIG. 1. Metalized film 2 includes dielectric film 1 and metal layer 3.

### <Dielectric Film>

Dielectric film 1 is the “processed dielectric film” or the “heat-treated dielectric film” described above.

### <Metal Layer>

Metal layer 3 is disposed on dielectric film 1. Metal layer 3 may be disposed on only one surface of dielectric film 1, or may be disposed on both surfaces thereof. Hereinafter, metalized film 2 in which metal layer 3 is disposed on only one surface of dielectric film 1 may be referred to as “single-sided metalized film”, and metalized film 2 in which metal layer 3 is disposed on both surfaces of dielectric film 1 may be referred to as “double-sided metalized film”. Metalized film 2 illustrated in FIG. 1 is a single-sided metalized film.

The pattern of metal layer 3 is not particularly limited, but for example, a continuous pattern extending in the MD direction is exemplified (see FIG. 1). Examples of other patterns of metal layers 3 include patterns described in Unexamined Japanese Patent Publication No. 2004-134561, Unexamined Japanese Patent Publication No.H02-033910, and Japanese Unexamined Utility Model Application Publication No. H03-101508.

In metalized film 2 illustrated in FIG. 1, margin 100 is present at one end in the TD direction on the surface on which metal layer 3 is disposed. Margin 100 is a portion where metal layer 3 is not disposed. That is, margin 100 is a portion where dielectric film 1 is exposed.

The material of metal layer 3 is not particularly limited, and examples thereof include aluminum (Al), gold (Au), magnesium (Mg), zinc (Zn), tin (Sn), nickel (Ni), chromium (Cr), iron (Fe), copper (Cu), titanium (Ti), and alloys thereof.

### (4) Method for Manufacturing Metalized Film

Next, a method for manufacturing metalized film 2 according to the present exemplary embodiment will be described. The method for manufacturing metalized film 2 includes a vapor deposition step.

### <Vapor Deposition Step>

In the vapor deposition step, a metal is vapor-deposited on dielectric film 1. For example, metal layer 3 is disposed on dielectric film 1 by vacuum vapor deposition while dielectric film 1 is fed in the MD direction in a vacuum chamber. Metalized film 2 is thus obtained.

### (5) Film Capacitor

Next, film capacitor 4 according to the present exemplary embodiment will be described with reference to FIGS. 1 and 2. Film capacitor 4 includes metalized film 2. Preferably, film capacitor 4 further includes end-face electrodes 5.

### <Metalized Film>

Metalized film 2 is included in film capacitor 4 as wound body 20. Wound body 20 is formed by winding metalized film 2. Wound body 20 may have a cylindrical shape as illustrated in FIG. 1 or may have an oblate cylindrical shape as illustrated in FIG. 2.

Wound body 20 illustrated in FIG. 1 is obtained by winding two single-sided metalized films (first metalized film 21 and second metalized film 22) in a stacking manner. Wound body 20 may be obtained by winding one double-sided metalized film and one dielectric film 1 in an stacking manner.

In wound body 20, first metal layer 31 of first metalized film 21 and second metal layer 32 of second metalized film 22 face each other with dielectric film 1 interposed therebetween.

On one end surface of wound body 20, a part of the first metal layer 31 is exposed, but the second metal layer 32 is not exposed.

On the other end surface of wound body 20, a part of the second metal layer 32 is exposed, but the first metal layer 31 is not exposed.

### <End-Face Electrode>

The end-face electrodes 5 are each connected to metal layer 3. In the present exemplary embodiment, film capacitor 4 includes a pair of end-face electrodes 5 (first end-face electrode 51 and second end-face electrode 52). First end-face electrode 51 is provided on one end surface of wound body 20. Therefore, the first end-face electrode 51 is connected to the first metal layer 31. On the other hand, the second end-face electrode 52 is provided on the other end surface of wound body 20. Therefore, the second end-face electrode 52 is connected to the second metal layer 32.

The material of the end-face electrode 5 is not particularly limited, and examples thereof include zinc (Zn), tin (Sn), and alloys thereof.

### (6) Method for Manufacturing Film Capacitor

Next, a method for manufacturing film capacitor 4 according to the present exemplary embodiment will be described with reference to FIGS. 1 and 2. The method for manufacturing film capacitor 4 includes a winding step. Preferably, the method for manufacturing film capacitor 4 further includes a thermal spraying step.

### <Winding Step>

In the winding step, metalized films 2 are wound. In FIG. 1, a pair of metalized films 2 (first metalized film 21 and second metalized film 22) are stacked and wound in circumferential direction θ about axis J. As a result, the cylindrical wound body 20 is formed. When wound body 20 is pressurized in one direction perpendicular to axis J as necessary, flattened wound body 20 having an oblate cylindrical shape is obtained.

### <Thermal Spraying Step>

In the thermal spraying step, metal is sprayed. Specifically, when metal is thermal-sprayed to one end (one end surface in the direction of axis J) of wound body 20, the first end-face electrode 51 is formed. On the other hand, when metal is thermal-sprayed to the other end (the other end surface in the direction of axis J) of wound body 20, the second end-face electrode 52 is formed.

In this way, film capacitor 4 illustrated in FIG. 2 is obtained.

### EFFECTS

Film capacitor 4 according to the present exemplary embodiment includes metalized films 2 according to the present exemplary embodiment, and therefore can have improved withstand voltage characteristics in a high-temperature environment. As described above, film capacitor 4 is suitable for applications in each of which stable operation in a high-temperature environment is required.

### (7) Inverter

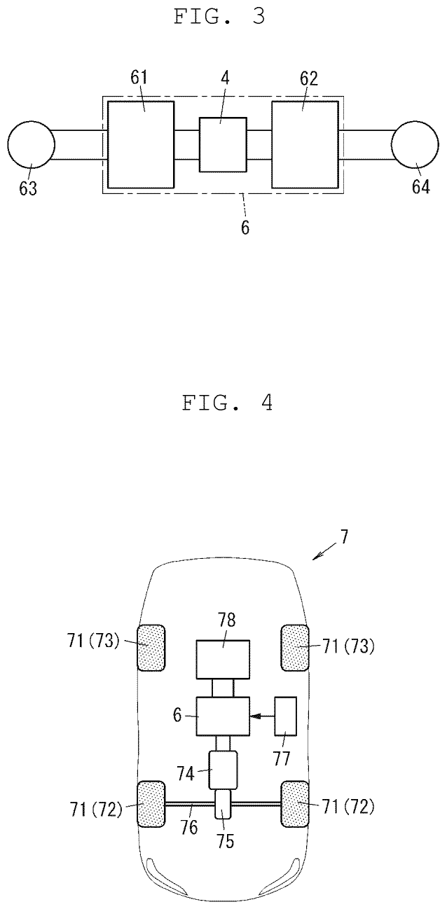

Next, inverter 6 according to the present exemplary embodiment will be described with reference to FIG. 3. The inverter 6 includes film capacitor 4, converter circuit 61, and inverter circuit 62.

Converter circuit 61 is a circuit that converts AC into DC, and is electrically connected to film capacitor 4.

Inverter circuit 62 is a circuit that changes a voltage and/or a frequency of AC when converting DC into AC, and is electrically connected to film capacitor 4.

Inverter 6 is used, for example, as follows. That is, converter circuit 61 of inverter 6 is connected to power supply 63, and inverter circuit 62 of inverter 6 is connected to motor 64. Note that power supply 63 and motor 64 are included in external devices.

Then, first, AC from the power supply 63 is converted into DC by converter circuit 61 of inverter 6, and the converted DC is regulated to a stable DC while film capacitor 4 repeats charging and discharging. Next, this DC is converted into AC at an optional voltage and frequency and output by inverter circuit 62 of inverter 6.

As described above, since inverter 6 includes film capacitor 4 according to the present exemplary embodiment, and can improve its reliability in a high-temperature environment.

### (8) Vehicle

Next, vehicle 7 according to the present exemplary embodiment will be described with reference to FIG. 4. In particular, a drive system of vehicle 7 will be mainly described.

Vehicle 7 according to the present exemplary embodiment includes inverter 6, AC motor 74, transmission 75, battery 77, electronic control unit 78, wheels 71 (front wheels 72 and rear wheels 73), front axle 76, and a rear axle (not illustrated). Vehicle 7 is an electric vehicle (EV car) that runs using AC motor 74 as a drive source.

Vehicle 7 employs a front wheel drive system (FF system). AC motor 74 as a drive source and transmission 75 are disposed in the front portion of the vehicle body. Transmission 75 changes the speed of the rotation of AC motor 74 and transmits the rotation to front axle 76.

Front axle 76 is disposed horizontally in the vehicle width direction. Front wheels 72 that are driving wheels are attached to left and right ends of front axle 76. At the rear portion of the vehicle body, a rear axle (not illustrated) is disposed in the vehicle width direction in parallel with front axle 76. Rear wheels 73 are attached to left and right ends of the rear axle.

Battery 77 is a DC power supply. The DC power supplied from battery 77 is converted into AC power by inverter 6 and supplied to AC motor 74, and AC motor 74 is rotationally driven by the AC power. The driving force (output) of AC motor 74 is controlled via inverter 6 operated by a control signal output from electronic control unit 78.

As described above, since vehicle 7 includes inverter 6 according to the present exemplary embodiment, and can have its reliability improved in a high-temperature environment.

### 3. Aspects

As apparent from the above-described exemplary embodiments, the present disclosure includes the following aspects. Hereinafter, reference numerals are given in parentheses only to clarify a correspondence relationship with the exemplary embodiments.

A first aspect is dielectric film (1) including polypropylene. In a diffraction pattern of X-ray diffraction measurement to dielectric film (1), a ratio (IB/IA) of a peak intensity IB to a peak intensity IA is 0.527 or more, the peak intensity IA being derived from a (040) plane of an α crystal of the polypropylene, the peak intensity IB being derived from a (060) plane of an α crystal of the polypropylene.

According to this aspect, it is possible to improve the withstand voltage characteristics in a high-temperature environment.

A second aspect is dielectric film (1) based on the first aspect. In the second aspect, 2.2≤(PB/PA) is satisfied, an orientation parameter PA in an MD direction (machine direction) of dielectric film (1) and an orientation parameter PB in a TD direction (transverse direction) of dielectric film (1) being respectively defined by the following expressions.

$$PA = ( A 972 / A 1376 )$$

$$PB = ( B 972 / B 1376 )$$

where
A972 represents an absorption peak intensity at a wavenumber of 972 cm⁻¹ in a Fourier Transform Infrared Spectroscopy spectrum measured in a state where a light source is polarized in the MD direction,
A1376 represents an absorption peak intensity at a wavenumber of 1376 cm⁻¹ in the Fourier Transform Infrared Spectroscopy spectrum measured in the state where the light source is polarized in the MD direction,
B972 represents an absorption peak intensity at a wavenumber of 972 cm⁻¹ in a Fourier Transform Infrared Spectroscopy spectrum measured in a state where the light source is polarized in the TD direction, and
B1376 represents an absorption peak intensity at a wavenumber of 1376 cm⁻¹ in the Fourier Transform Infrared Spectroscopy spectrum measured in the state where the light source is polarized in the TD direction.

According to this aspect, it is possible to further improve the withstand voltage characteristics in a high-temperature environment.

A third aspect is dielectric film (1) based on the first or second aspect. In the third aspect, (PB/PA)≤2.4 is satisfied.

According to this aspect, it is possible to further improve the withstand voltage characteristics in a high-temperature environment while suppressing a crack.

A fourth aspect is a dielectric film (1) including polypropylene. In the fourth aspect, 2.2≤(PB/PA) is satisfied, an orientation parameter PA in an MD direction (machine direction) of the dielectric film (1) and an orientation parameter PB in a TD direction (transverse direction) of the dielectric film (1) being respectively defined by the following expressions.

$$PA = ( A 972 / A 1376 )$$

$$PB = ( B 972 / B 1376 )$$

where
A972 represents an absorption peak intensity at a wavenumber of 972 cm⁻¹ in a Fourier Transform Infrared Spectroscopy spectrum measured in a state where a light source is polarized in the MD direction,
A1376 represents an absorption peak intensity at a wavenumber of 1376 cm⁻¹ in the Fourier Transform Infrared Spectroscopy spectrum measured in the state where the light source is polarized in the MD direction,
B972 represents an absorption peak intensity at a wavenumber of 972 cm⁻¹ in a Fourier Transform Infrared Spectroscopy spectrum measured in a state where the light source is polarized in the TD direction, and
B1376 represents an absorption peak intensity at a wavenumber of 1376 cm⁻¹ in the Fourier Transform Infrared Spectroscopy spectrum measured in the state where the light source is polarized in the TD direction.

According to this aspect, it is possible to improve the withstand voltage characteristics in a high-temperature environment.

A fifth aspect is dielectric film (1) based on the fourth aspect. In the fifth aspect, (PB/PA)≤2.4 is satisfied.

According to this aspect, it is possible to further improve the withstand voltage characteristics in a high-temperature environment while suppressing a crack.

A sixth aspect is metalized film (2) including: dielectric film (1) according to any one of the first to fifth aspects; and metal layer (3) disposed on dielectric film (1).

According to this aspect, it is possible to improve the withstand voltage characteristics in a high-temperature environment.

A seventh aspect is film capacitor (4) including metalized film (2) according to the sixth aspect.

According to this aspect, it is possible to improve the withstand voltage characteristics in a high-temperature environment.

An eighth aspect is inverter (6) including film capacitor (4) according to the seventh aspect.

According to this aspect, reliability in a high-temperature environment can be improved.

A ninth aspect is vehicle (7) including inverter (6) according to the eighth aspect.

According to this aspect, reliability in a high-temperature environment can be improved.

A tenth aspect is a method for manufacturing a dielectric film (1). The method includes: a preparation step of preparing a dielectric film including polypropylene; and a processing step of subjecting the dielectric film to tensile processing at a tensile stress more than or equal to a yield point of dielectric film (1), the tensile processing being performed at a temperature of 80° C. or lower.

According to this aspect, it is possible to obtain dielectric film (1) with improved withstand voltage characteristics in a high-temperature environment.

An eleventh aspect is the method for manufacturing dielectric film (1) based on the tenth aspect. In an eleventh aspect, in the processing step, a tensile stress in the tensile processing is 50 MPa or more and 100 MPa or less.

According to this aspect, it is possible to obtain dielectric film (1) that suppresses cracking while having further improved withstand voltage characteristics in a high-temperature environment.

A twelfth aspect is the method for manufacturing dielectric film (1) based on the tenth or eleventh aspect. In a twelfth aspect, in the processing step, a tensile direction of the tensile processing coincides with an MD direction (machine direction) of the dielectric film.

According to this aspect, it is possible to obtain dielectric film (1) with further improved withstand voltage characteristics in a high-temperature environment.

A thirteenth aspect is the method for manufacturing dielectric film (1) based on any one of the tenth to twelfth aspects. In the thirteenth aspect, the method further includes a heat treatment step of heating the dielectric film at a temperature of 110° C. or higher and 140° C. or lower after the processing step.

According to this aspect, it is possible to obtain dielectric film (1) with further improved withstand voltage characteristics in a high-temperature environment.

A fourteenth aspect is a method for manufacturing metalized film (2), including a vapor deposition step of vapor-depositing a metal on dielectric film (1) according to any one of the first to fifth aspects.

According to this aspect, it is possible to obtain metalized film (2) with improved withstand voltage characteristics in a high-temperature environment.

A fifteenth aspect is a method for manufacturing film capacitor (4). The method includes a winding step of winding metalized film (2) according to the sixth aspect.

According to this aspect, it is possible to obtain film capacitor (4) with improved withstand voltage characteristics in a high-temperature environment.

What is claimed is:

1. A dielectric film comprising polypropylene, wherein
in a diffraction pattern of X-ray diffraction measurement to the dielectric film, a ratio (IB/IA) of a peak intensity IB to a peak intensity IA is 0.527 or more, the peak intensity IA being derived from a (040) plane of an α crystal of the polypropylene, the peak intensity IB being derived from a (060) plane of an α crystal of the polypropylene.

2. The dielectric film according to claim 1, wherein
2.2≤(PB/PA) is satisfied, an orientation parameter PA in an MD direction (machine direction) of the dielectric film and an orientation parameter PB in a TD direction (transverse direction) of the dielectric film being respectively defined by the following expressions:
$$PA = ( A 972 / A 1376 )$$
$$PB = ( B 972 / B 1376 )$$
where
A972 represents an absorption peak intensity at a wavenumber of 972 cm⁻¹ in a Fourier Transform Infrared Spectroscopy spectrum measured in a state where a light source is polarized in the MD direction,
A1376 represents an absorption peak intensity at a wavenumber of 1376 cm⁻¹ in the Fourier Transform Infrared Spectroscopy spectrum measured in the state where the light source is polarized in the MD direction,
B972 represents an absorption peak intensity at a wavenumber of 972 cm⁻¹ in a Fourier Transform Infrared Spectroscopy spectrum measured in a state where the light source is polarized in the TD direction, and
B1376 represents an absorption peak intensity at a wavenumber of 1376 cm⁻¹ in the Fourier Transform Infrared Spectroscopy spectrum measured in the state where the light source is polarized in the TD direction.

3. The dielectric film according to claim 2, wherein
(PB/PA)≤2.4 is satisfied.

4. A dielectric film comprising polypropylene, wherein
2.2≤(PB/PA) is satisfied, an orientation parameter PA in an MD direction (machine direction) of the dielectric film and an orientation parameter PB in a TD direction (transverse direction) of the dielectric film being respectively defined by the following expressions:
$$PA = ( A 972 / A 1376 )$$
$$PB = ( B 972 / B 1376 )$$
where
A972 represents an absorption peak intensity at a wavenumber of 972 cm⁻¹ in a Fourier Transform Infrared Spectroscopy spectrum measured in a state where a light source is polarized in the MD direction,
A1376 represents an absorption peak intensity at a wavenumber of 1376 cm⁻¹ in the Fourier Transform Infrared Spectroscopy spectrum measured in the state where the light source is polarized in the MD direction,
B972 represents an absorption peak intensity at a wavenumber of 972 cm⁻¹ in a Fourier Transform Infrared Spectroscopy spectrum measured in a state where the light source is polarized in the TD direction, and
B1376 represents an absorption peak intensity at a wavenumber of 1376 cm⁻¹ in the Fourier Transform Infrared Spectroscopy spectrum measured in the state where the light source is polarized in the TD direction.

5. The dielectric film according to claim 4, wherein
(PB/PA)≤2.4 is satisfied.

6. A metalized film comprising:
the dielectric film according to claim 1; and
a metal layer disposed on the dielectric film.

7. A metalized film comprising:
the dielectric film according to claim 4; and
a metal layer disposed on the dielectric film.

8. A film capacitor comprising the metalized film according to claim 6.

9. A film capacitor comprising the metalized film according to claim 7.

10. An inverter comprising the film capacitor according to claim 8.

11. An inverter comprising the film capacitor according to claim 9.

12. A vehicle comprising the inverter according to claim 10.

13. A vehicle comprising the inverter according to claim 11.

14. A method for manufacturing a dielectric film, the method comprising:
a preparation step of preparing a dielectric film including polypropylene; and
a processing step of subjecting the dielectric film to tensile processing at a tensile stress more than or equal to a yield point of the dielectric film, the tensile processing being performed at a temperature of 80° C. or lower.

15. The method for manufacturing a dielectric film according to claim 14, wherein
in the processing step, the tensile stress in the tensile processing is 50 MPa or more and 100 MPa or less.

16. The method for manufacturing a dielectric film according to claim 14, wherein
in the processing step, a tensile direction of the tensile processing coincides with an MD direction (machine direction) of the dielectric film.

17. The method for manufacturing a dielectric film according to claim 14, further comprising a heat treatment step of heating the dielectric film at a temperature of 110° C. or higher and 140° C. or lower after the processing step.

18. A method for manufacturing a metalized film, the method comprising a vapor deposition step of vapor-depositing a metal on the dielectric film according to claim 1.

19. A method for manufacturing a metalized film, the method comprising a vapor deposition step of vapor-depositing a metal on the dielectric film according to claim 4.

20. A method for manufacturing a film capacitor, the method comprising a winding step of winding the metalized film according to claim 6.
